(19) United States
(12) Patent Application Publication
(10) Pub. No.: US 2012/0037143 A1
(43) Pub. Date: Feb. 16, 2012

(54) SPACE-EXTENDABLE BAKING OVEN

(76) Inventor: KIOSKY CHUNG, Taichung (TW)

(21) Appl. No.: 12/853,314

(22) Filed: Aug. 10, 2010

(51) Int. Cl. A47J 37/07

(52) U.S. Cl. 126/25 R

(57) ABSTRACT

A space-extendable baking oven comprises a body; a receiving frame for supporting the body; at least one wing portion of the frame being installed with a lateral table; and an extending frame installed to trenches of the lateral table; wherein the extending frame can be pulled outwards or received into the trenches. The extending frame can support an extension table. The receiving frame has at least one receiving space for receiving the extension table. Furthermore, in another application, the extending frame may be rotatably installed to lateral table so that the extending frame can tune down or turn upwards. The present invention provides a larger space for receiving other objects. Furthermore, the use is convenient so as to effectively resolve the problem of insufficient space in the prior art oven.

### FIELD OF THE INVENTION

The present invention relates to ovens, and in particular to a space-extendable baking oven

### BACKGROUND OF THE INVENTION

Meal grilling is a popular action not only in cooking, but also in social contact actions. For meal grilling, many different kinds of ovens are developed so as to provide the users convenience usage in meal grilling.

Currently, large size ovens become more and more popular for users. These ovens provide various functions of meal grilling. It is convenient in using, movement and storage. The prior art oven in grilling meal has a body and a frame installed below the body. The body serves for grilling meal. The two winds of a seat of the body are installed with lateral tables for placing foods or bowls, bottles, or cans, etc.

However, practically, the areas of the lateral tables are insufficient so that the user will feel inconvenient.

### SUMMARY OF THE INVENTION

The object of the present invention is to provide a space-extendable baking oven, which can resolve the problem of insufficient space in ovens. In the present invention, the space-extendable baking oven comprises a body; a receiving frame for supporting the body; at least one wing portion of the frame being installed with a lateral table; and an extending frame installed to trenches of the lateral table; wherein the extending frame can be pulled outwards or received into the trenches. The extending frame can support an extension table. The receiving frame has at least one receiving space for receiving the extension table. Furthermore, in another application, the extending frame may be rotatably installed to lateral table so that the extending frame can tune down or turn upwards. The present invention provides a larger space for receiving other objects. Furthermore, the use is convenient so as to effectively resolve the problem of insufficient space in the prior art oven.

The various objects and advantages of the present invention will be more readily understood from the following detailed description when read in conjunction with the appended drawing.

### BRIEF DESCRIPTION OF THE DRAWINGS

FIG. 1 is a structural schematic view about the first embodiment of the present invention.

FIG. 2 shows that the structure in FIG. 1 is at an assembled state.

FIG. 3 is a schematic view showing the application of the present invention.

FIG. 4 is a schematic view showing another application of the present invention.

FIG. 5 is a schematic view showing a further application of the present invention.

FIG. 6 is a structural schematic view showing the second application of the present invention.

FIG. 7 is a schematic view showing the application in the second embodiment of the present invention.

FIG. 8 is a structural schematic view about the third embodiment of the present invention.

FIG. 9 is a schematic view showing the application in the third embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

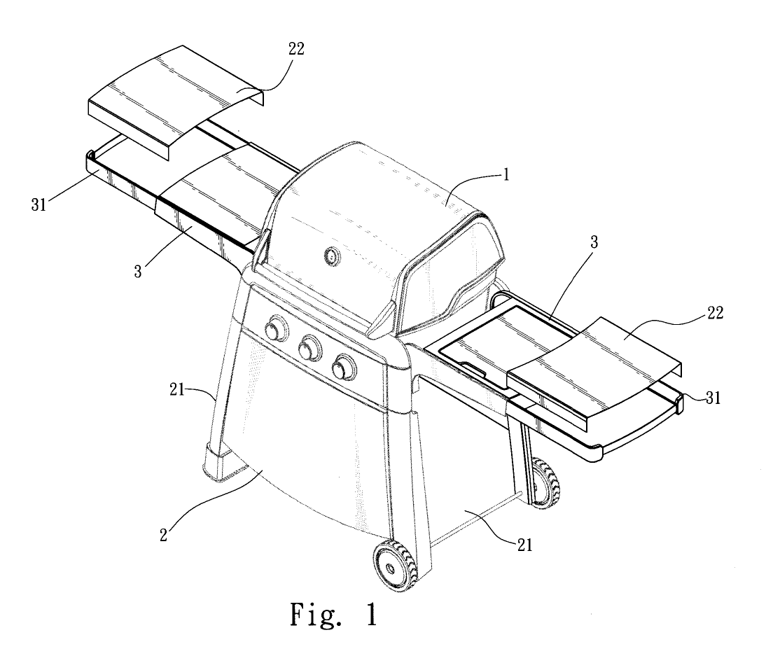

With reference to FIG. 1, the structure about the first embodiment of the present invention is illustrated. The oven of the present invention includes the following elements.

A body 1 is included.

A supporting frame 2 serves for supporting the body 1. At least one wing of the supporting frame 2 is installed with a lateral table 3 for receiving other objects. The frame 2 has at least one receiving space 21 for receiving an extension table 22.

An extending frame 31 is installed to trenches at two lateral sides of the lateral table 3 which is extendable outwards or inserted back to the trenches. After the extension table 22 is taken out from the receiving space 21, the extension table 22 can be placed upon the extending frame 31 for receiving other objects.

Two sides of the extension table 22 have respective folded edges 221 for clamping the extending frame 31 as the extension table 22 is placed upon the extending frame 31 so that the extension table 22 is retained without sliding.

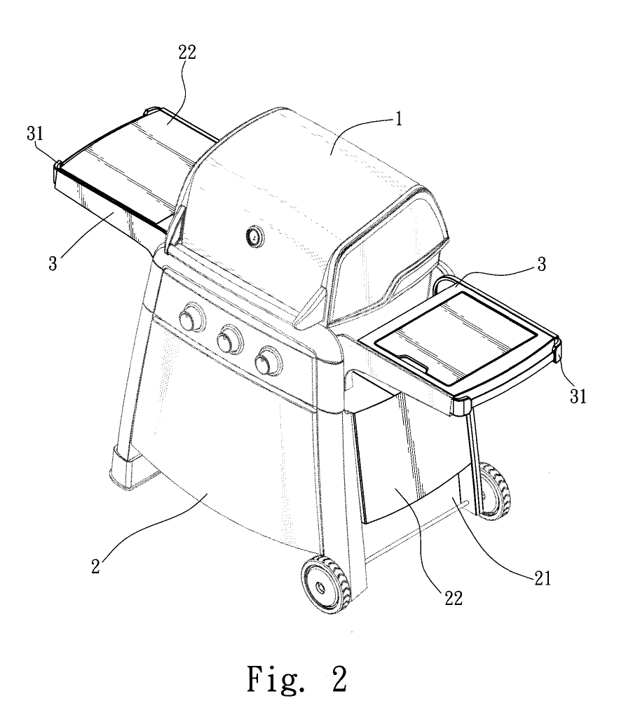

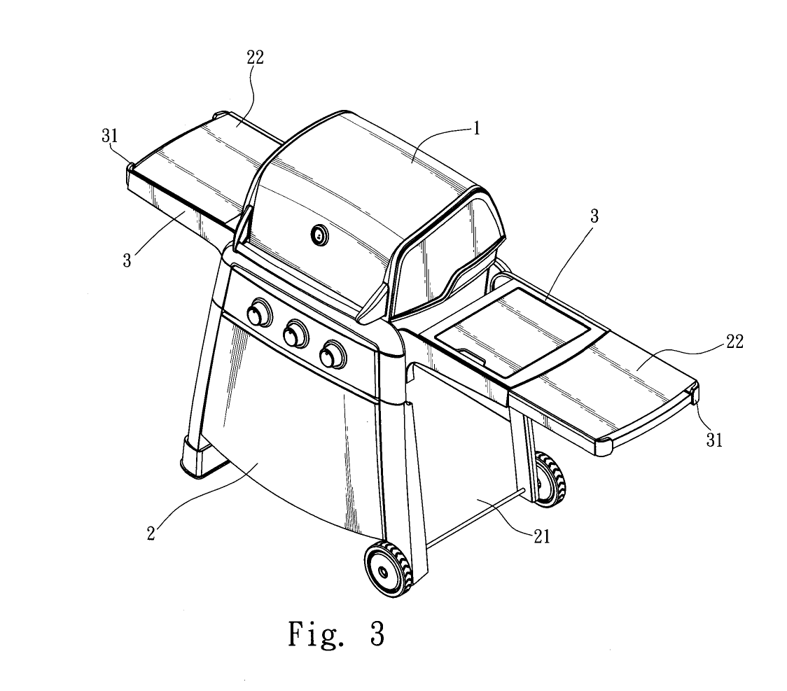

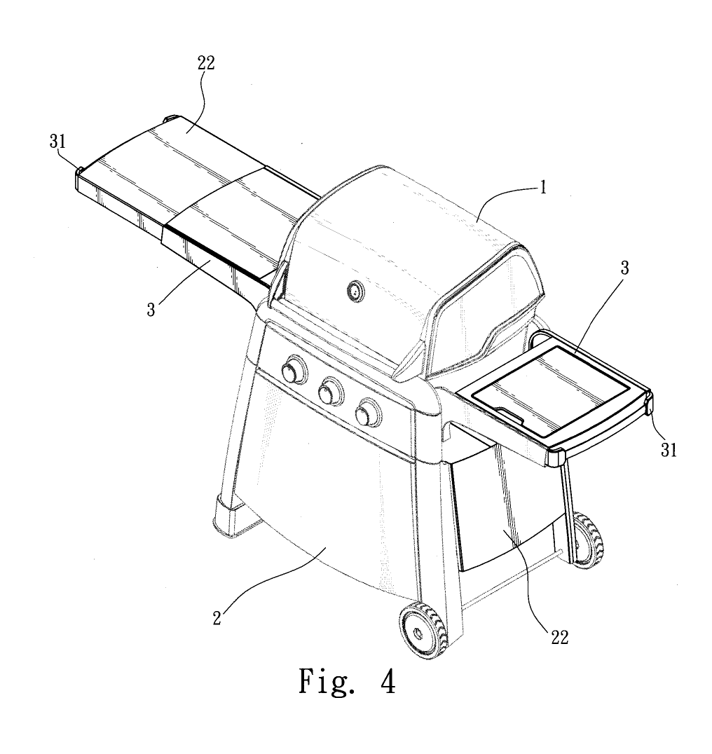

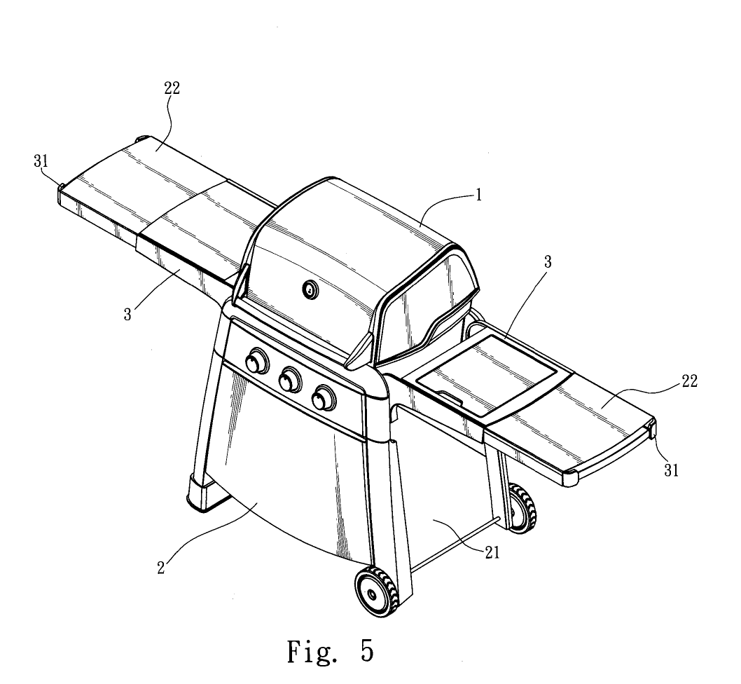

FIG. 2 shows that the structure of the present invention is in an un-expanding state. FIG. 3 shows one application of the present invention. FIG. 4 shows another application of the present invention. FIG. 5 shows a further application of the present invention.

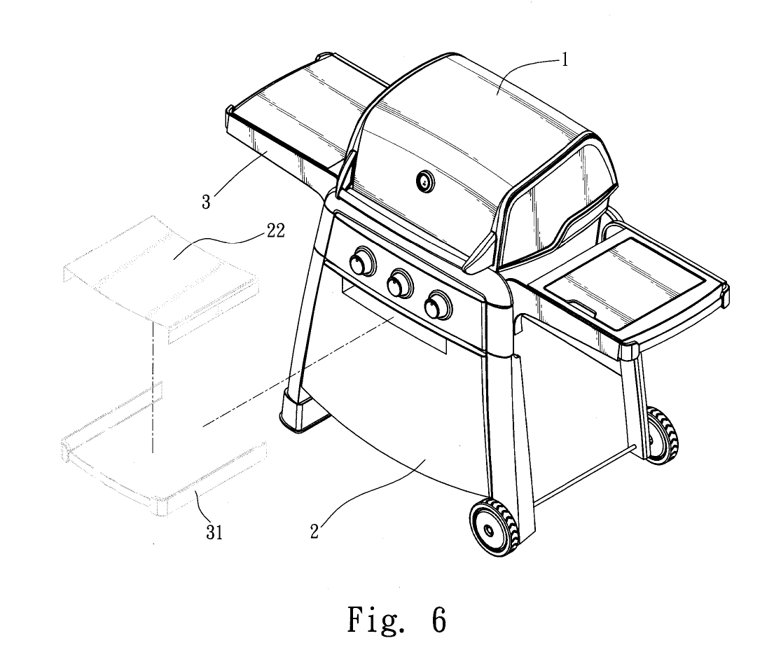

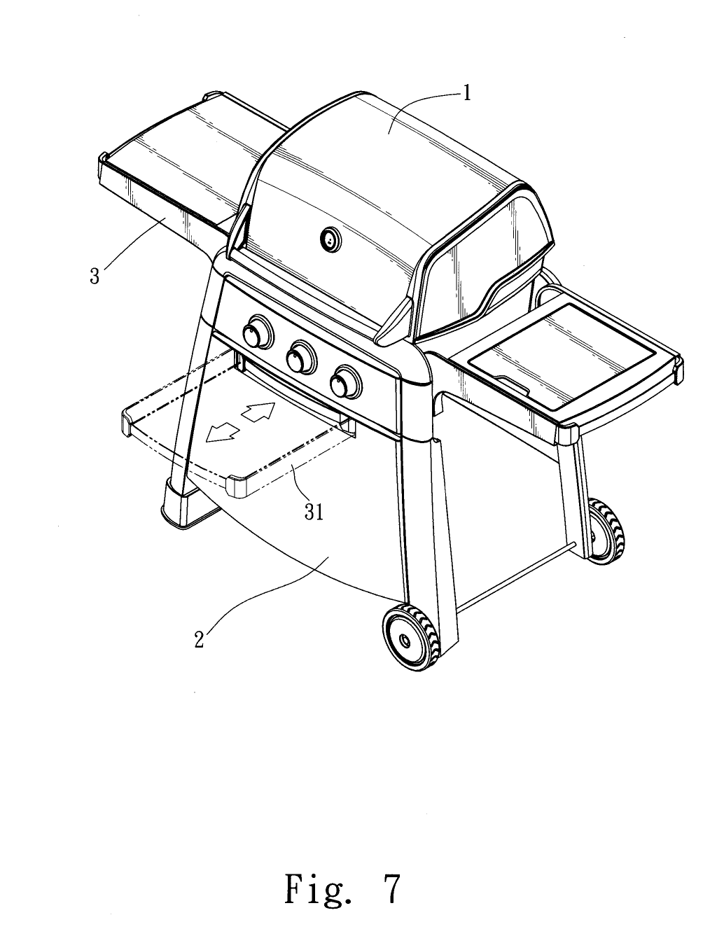

FIGS. 6 and 7 show the second embodiment of the present invention. A front side of the frame 2 has holes for installing the supporting frame 2 which is extendable outwards or folded. The extending frame 31 can install the extension table 22 for providing more space to receive other objects.

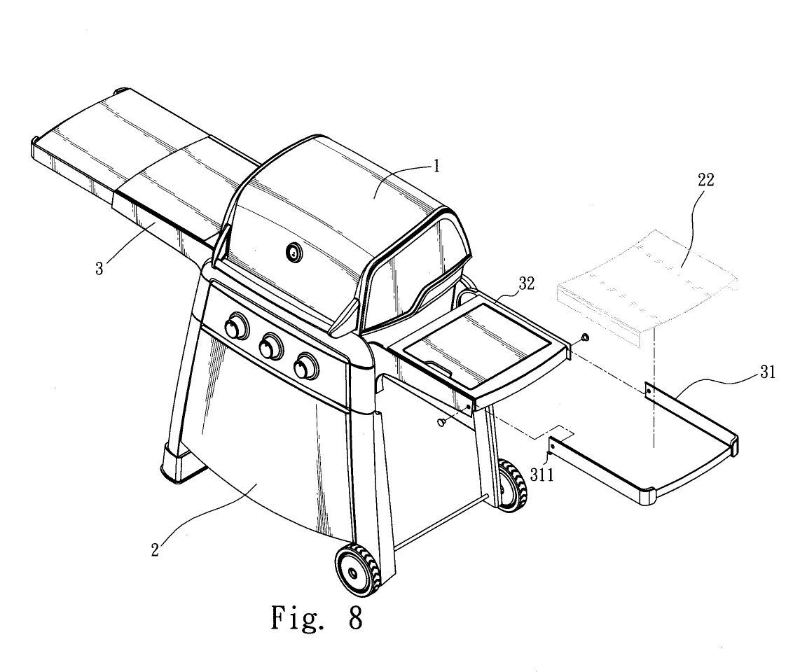

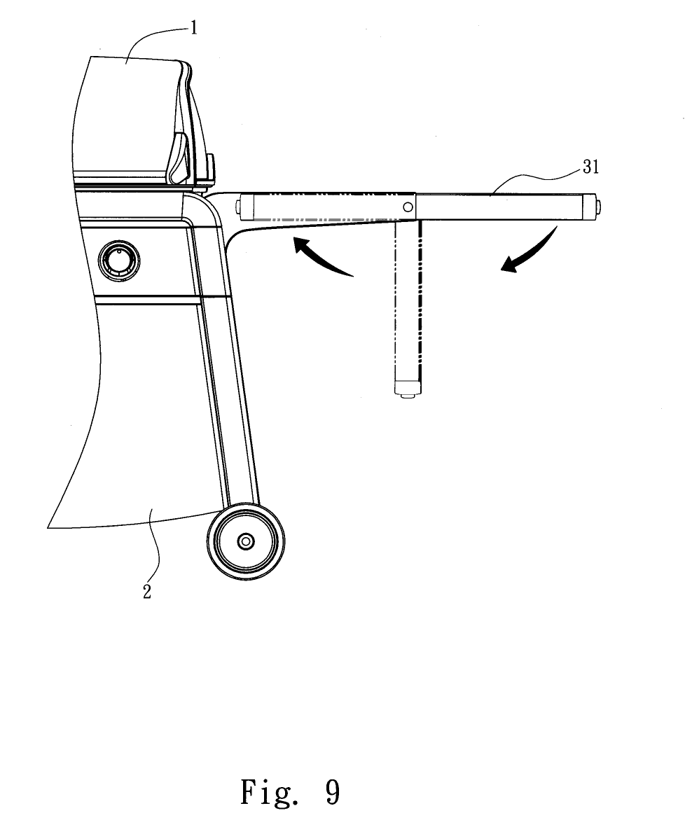

FIGS. 8 and 9 show the third embodiment of the present invention. It is illustrated that the extension table 22 is locked to the extending frame 31 at two ends thereof by using studs or screws by that the extending frame 31 is rotateable with respect to the lateral table 3.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A space-extendable baking oven, comprising:
a body;
a receiving frame for supporting the body; at least one wing portion of the frame being installed with a lateral table; and
an extending frame installed to trenches of the lateral table;
wherein the extending frame can be pulled outwards or received into the trenches; and
wherein the extending frame can support an extension table.

2. The space-extendable baking oven as claimed in claim 1, wherein the receiving frame has at least one receiving space for receiving the extension table.

3. The space-extendable baking oven as claimed in claim 1, wherein
two edges of the extension table have respective folded edges for engaging with the extending frame.

4. The space-extendable baking oven as claimed in claim 1, wherein a front side of the receiving frame is formed with holes for installing the extending frame so that the extension table can be placed upon the extending frame.

5. A space-extendable baking oven, comprising:
a body;
a receiving frame for supporting the body; at least one wing portion of the frame being installed with a lateral table; and
an extending frame rotatably installed to lateral table so that the extending frame can tune down or turn upwards and
wherein the extending frame can support an extension table.

6. The space-extendable baking oven as claimed in claim 5, wherein the extending frame is combined to the lateral table at the two edges so that the extending frame is rotatable longitudinally.

7. The space-extendable baking oven as claimed in claim 5, wherein the receiving frame has at least one receiving space for receiving the extension table.

8. The space-extendable baking oven as claimed in claim 5, wherein
two edges of the extension table have respective folded edges for engaging with the extending frame.

9. The space-extendable baking oven as claimed in claim 8, wherein the extending frame is installed with at least one stop for stopping against the lateral table as the extending frame is pulled out.
